(19) United States
(12) Patent Application Publication
(10) Pub. No.: US 2023/0281675 A1
(43) Pub. Date: Sep. 7, 2023

(54) System and Method for Evaluating Residual Value of Vehicle

(71) Applicants: Hyundai Motor Company, Seoul (KR); Kia Corporation, Seoul (KR)

(72) Inventors: Nam Chung Paik, Goyang-si (KR); Jaho Koo, Seoul (KR); Min Seok Choi, Seoul (KR); Kimyoung Hong, Seoul (KR); Jimin Lee, Seoul (KR)

(21) Appl. No.: 17/879,586

(22) Filed: Aug. 2, 2022

(30) Foreign Application Priority Data
Mar. 7, 2022 (KR) 10-2022-0028705

(51) Int. Cl. G06Q 30/02; G07C 5/00; G07C 5/08; G06F 17/18

(52) U.S. Cl. CPC G06Q 30/0278; G06Q 30/0283; G07C 5/008; G07C 5/0808; G06F 17/18

(57) ABSTRACT

An embodiment is A system for evaluating a residual value of a vehicle, the system including a service-providing server configured to receive a residual value evaluation request for the vehicle from a user terminal, calculate a reference market price of the vehicle by using basic information of the vehicle and a regression coefficient corresponding to the basic information of the vehicle, receive connected car information from the vehicle, calculate an influence value of the connected car information by using the received connected car information, determine a depreciation ratio for each accident portion of the vehicle, evaluate the residual value of the vehicle by using the reference market price, the influence value of the connected car information and the depreciation ratio, and transmit a residual value evaluation result of the vehicle to the user terminal in response to the request.

### CROSS-REFERENCE TO RELATED APPLICATIONS

This application claims priority to and the benefit of Korean Patent Application No. 10-2022-0028705 filed in the Korean Intellectual Property Office on Mar. 7, 2022, the entire contents of which are incorporated herein by reference.

### TECHNICAL FIELD

The present invention relates to system and method for evaluating a residual value of a vehicle.

### BACKGROUND

A domestic used car market is continuously growing, and a used car trading business has recently been released from a business designated as suitable for small and medium-sized enterprises (SMEs), thus increasing opportunities for new business in the market. In a conventional used car market, the performance and condition inspection of a used car may be poor, and thus a price calculation is not transparent. Accordingly, a consumer may have a low confidence in a price of the used car.

Therefore, there is a need to develop a system which may objectively evaluate the price of the used car, based on vehicle data.

The above information disclosed in this background section is only for enhancement of understanding of the background of the invention, and therefore it may contain information that does not form the prior art that is already known to a person of ordinary skill in the art.

### SUMMARY

An exemplary embodiment of the present invention provides a system and method for evaluating a residual value of a vehicle, which may resolve information asymmetry between a consumer and a used car dealer for information that is difficult for the consumer to check accurate information, such as driving information and durability information, and enable a vehicle owner to understand the residual value of his/her vehicle in real time.

According to an exemplary embodiment of the present invention, a system for evaluating a residual value of a vehicle includes a service-providing server receiving a residual value evaluation request for the vehicle from a user terminal, and transmitting a residual value evaluation result of the vehicle to the user terminal in response to the request, wherein the service-providing server calculates a reference market price of the vehicle by using basic information of the vehicle and a regression coefficient corresponding to the basic information of the vehicle, receives connected car information from the vehicle, calculates an influence value of the connected car information by using the received connected car information, determines a depreciation ratio for each accident portion, and evaluates the residual value of the vehicle by using the reference market price, the influence value of the connected car information and the depreciation ratio.

The service-providing server may include an influence value calculation module calculating the influence value of the connected car information by using an influence of each detailed item in a category of the connected car information and a weight of each category in the connected car information, and a residual value evaluation module evaluating the residual value of the vehicle by multiplying the depreciation ratio by a sum of the reference market price and the influence value of the connected car information, the connected car information including the plurality of detailed items, and the plurality of detailed items being classified into at least two categories.

The influence value calculation module may calculate an influence value of each detailed item by using the influence of each detailed item and the weight of the corresponding category, for each of the plurality of detailed items, and calculate the influence value of the connected car information by summing the influence values of the plurality of detailed items to each other, the influence of each detailed item being a value calculated using a weighted average method or a curve estimation method.

The influence value calculation module may calculate the influence value of each detailed item with respect to at least one of the plurality of detailed items by using Equation 1:

Influence value of each detailed item=(Influence of corresponding detailed item)×(Weight of category corresponding to corresponding detailed item). [Equation 1]

The influence value calculation module may calculate the influence value of each detailed item with respect to at least one of the plurality of detailed items by using Equation 2:

Influence value of each detailed item={b0+(b1×(Value of corresponding detailed item))+(b2×(Value of corresponding detailed item²))}×(Weight of category corresponding to corresponding detailed item). [Equation 2]

Here, b0 is a first influence of the corresponding detailed item of the connected car information, b1 is a second influence of the corresponding detailed item of the connected car information, and b2 is a third influence of the corresponding detailed item of the connected car information.

The influence value calculation module may calculate the influence value of each detailed item with respect to at least one of the plurality of detailed items by using Equation 3:

Influence value of each detailed item={c0+(c1×Value of corresponding detailed item)+(c2×Value of corresponding detailed item²)+(c3×Value of corresponding detailed item³)}×(Weight of category corresponding to corresponding detailed item). [Equation 3]

Here, c0 is a first influence of the corresponding detailed item of the connected car information, c1 is a second influence of the corresponding detailed item of the connected car information, c2 is a third influence of the corresponding detailed item of the connected car information, and c3 is a fourth influence of the corresponding detailed item of the connected car information.

The vehicle may transmit real-time connected car information up to time when the connected car information is requested from the service-providing server to the service-providing server, and the service-providing server may evaluate the residual value by using the real-time connected car information provided from the vehicle.

The connected car information may include driving information, the driving information including information on the regional driving ratio, driving ratio for each road type, idling ratio, rapid acceleration/deceleration ratio, and high revolution per minute (RPM) maintenance ratio of the vehicle.

The connected car information may include durability information, the durability information including information on the engine overload, transmission overload, engine operation number, and transmission operation number of the vehicle.

The service-providing server may further include a reference market price calculation module calculating the reference market price by using the basic information as its detailed items, information on at least one of the mileage, vehicle age, fuel type, engine displacement, vehicle brand, cruising distance, battery capacity and body type of the vehicle, price information, and constant and regression coefficient of each detailed item in the basic information, and a depreciation module determining the depreciation ratio to be applied when evaluating the residual value of the vehicle by using the accident portion of the vehicle and the depreciation ratio for each accident portion.

According to another exemplary embodiment of the present invention, a method for evaluating a residual value of a vehicle includes receiving a residual value evaluation request for the vehicle from a user terminal, calculating a reference market price of the vehicle by using basic information of the vehicle and a regression coefficient corresponding to the basic information of the vehicle, receiving connected car information from the vehicle, calculating an influence value of the connected car information by using the received connected car information, determining a depreciation ratio for each accident portion, and evaluating the residual value of the vehicle by using the reference market price, the influence value of the connected car information and the depreciation ratio.

The calculating of the influence value may include calculating the influence value of the connected car information by using an influence of each detailed item in a category of the connected car information and a weight of each category in the connected car information, and the evaluating of the residual value may include evaluating the residual value of the vehicle by multiplying the depreciation ratio by a sum of the reference market price and the influence value of the connected car information, the connected car information including the plurality of detailed items, and the plurality of detailed items being classified into at least two categories.

The calculating of the influence value of the connected car information may include calculating an influence value of each detailed item by using the influence of each detailed item and the weight of the corresponding category, for each of the plurality of detailed items, and calculating the influence value of the connected car information by summing the influence values of the plurality of detailed items to each other, the influence of each detailed item being a value calculated using a weighted average method or a curve estimation method.

The calculating of the influence value may include calculating the influence value of each detailed item with respect to at least one of the plurality of detailed items by using Equation 1:

Influence value of each detailed item=(Influence of corresponding detailed item)×(Weight of category corresponding to corresponding detailed item). [Equation 1]

The calculating of the influence value may include calculating the influence value of each detailed item with respect to at least one of the plurality of detailed items by using Equation 2:

Influence value of each detailed item={b0+(b1×(Value of corresponding detailed item))+(b2×(Value of corresponding detailed item²))}×(Weight of category corresponding to corresponding detailed item). [Equation 2]

Here, b0 is a first influence of the corresponding detailed item of the connected car information, b1 is a second influence of the corresponding detailed item of the connected car information, and b2 is a third influence of the corresponding detailed item of the connected car information.

The calculating of the influence value may include calculating the influence value of each detailed item with respect to at least one of the plurality of detailed items by using Equation 3:

Influence value of each detailed item={c0+(c1×Value of corresponding detailed item)+(c2×Value of corresponding detailed item²)+(c3×Value of corresponding detailed item³)}×(Weight of category corresponding to corresponding detailed item). [Equation 3]

Here, c0 is a first influence of the corresponding detailed item of the connected car information, c1 is a second influence of the corresponding detailed item of the connected car information, c2 is a third influence of the corresponding detailed item of the connected car information, and c3 is a fourth influence of the corresponding detailed item of the connected car information.

The receiving of the connected car information from the vehicle may include receiving real-time connected car information up to time when the connected car information is requested from the vehicle, and the evaluating of the residual value may include evaluating the residual value by using the real-time connected car information provided from the vehicle.

The connected car information may include at least one of driving information and durability information, the driving information including information on the regional driving ratio, driving ratio for each road type, idling ratio, rapid acceleration/deceleration ratio and high revolution per minute (RPM) maintenance ratio of the vehicle, and the durability information including information on the engine overload, transmission overload, engine operation number and transmission operation number of the vehicle.

The calculating of the reference market price may include calculating the reference market price by using the basic information as its detailed items, information on at least one of the mileage, vehicle age, fuel type, engine displacement, vehicle brand, cruising distance, battery capacity and body type of the vehicle, price information, and constant and regression coefficient of each detailed item in the basic information, and the determining of the depreciation ratio for each accident portion may include determining the depreciation ratio to be applied when evaluating the residual value of the vehicle by using the accident portion of the vehicle and the depreciation ratio for each accident portion.

According to yet another exemplary embodiment of the present invention, a vehicle may include a service-providing device calculating a reference market price of the vehicle by using basic information of the vehicle and a regression coefficient corresponding to the basic information of the vehicle, calculating an influence value of connected car information by using the connected car information, determining a depreciation ratio for each accident portion, and evaluating the residual value of the vehicle by using the reference market price, the influence value of the connected car information and the depreciation ratio when receiving a residual value evaluation request for the vehicle, wherein the connected car information is real-time information up to time when the residual value evaluation request is received.

As set forth above, it is possible to provide the system and method for evaluating the residual value of a vehicle which may resolve information asymmetry between the consumer and the used car dealer for the information that is difficult for the consumer to check the accurate information, such as the driving information and the durability information, by using the connected car, and identify the residual value of the vehicle in real time.

### BRIEF DESCRIPTION OF THE DRAWINGS

FIG. 1 is a block diagram schematically showing a configuration of a system for evaluating a residual value of a vehicle according to an exemplary embodiment.

FIG. 2 is a flowchart showing a method for evaluating a residual value of a vehicle according to an exemplary embodiment.

FIG. 3 is a diagram showing a method of calculating a reference market price of a semi-large internal combustion engine vehicle according to an exemplary embodiment.

FIG. 4 is a diagram showing a method of calculating an influence value of the semi-large internal combustion engine vehicle according to an exemplary embodiment.

FIG. 5 is a diagram showing a method of determining a depreciation ratio of the semi-large internal combustion engine vehicle according to an exemplary embodiment.

FIG. 6 is a diagram showing a method of calculating a reference market price of an electric vehicle according to an exemplary embodiment.

FIG. 7 is a diagram showing a method of calculating an influence value of the electric vehicle according to an exemplary embodiment.

FIG. 8 is a diagram showing a method of determining a depreciation ratio of the electric vehicle according to an exemplary embodiment.

FIGS. 9A to 9C show screens providing a service evaluating the residual value of a vehicle according to an exemplary embodiment.

FIG. 10 is a block diagram schematically showing a configuration of a vehicle according to an exemplary embodiment.

The following reference identifiers may be used in connection with the accompanying drawings to describe exemplary embodiments of the present disclosure.
1: system for evaluating the residual value of a vehicle
10: vehicle
101: ECU (Electronic Control Unit)
103: communication module
105: memory
107: input/output unit
20: service-providing server
201: control module
203: reference market price calculation module
205: influence value calculation module
207: depreciation module
209: residual value evaluation module
211: communication module
213: database
30: user terminal
301: application
40: sales server
50: maintenance server
60: service-providing device
601: control module
603: reference market price calculation module
605: influence value calculation module
607: depreciation module
609: residual value evaluation module
611: database

### DETAILED DESCRIPTION OF ILLUSTRATIVE EMBODIMENTS

Hereinafter, exemplary embodiments disclosed in the present specification are described in detail with reference to the accompanying drawings, components that are the same as or similar to each other are denoted by the same or similar reference numerals, and an overlapped description thereof is omitted. Terms “module” and/or “unit” for components used in the following description are used only to easily make the present specification. Therefore, these terms do not have meanings or roles distinguished from each other in themselves. Further, when it is decided that a detailed description for the known art related to the present invention may obscure the gist of the present invention, the detailed description will be omitted. Further, it should be understood that the accompanying drawings are provided only to allow exemplary embodiments of the present invention to be easily understood, and the spirit of the present invention is not limited by the accompanying drawings, but includes all the modifications, equivalents, and substitutions included in the spirit and scope of the present invention.

Terms including ordinal numbers such as ‘first’, ‘second’ and the like, may be used to describe various components. However, these components are not limited by these terms. The terms are used only to distinguish one component from another component.

It is to be understood that terms “include” or “have” used in the present specification specify the presence of features, numerals, steps, operations, elements or parts, which are mentioned in the present specification, or combinations thereof, but do not preclude the presence or addition of one or more other features, numerals, steps, operations, elements, parts or combinations thereof.

A program implemented as a set of instructions embodying a control algorithm necessary to control another configuration may be installed in a configuration for controlling another configuration under a specific control condition among configurations according to an exemplary embodiment. The control configuration may process input data and stored data, based on an installed program to generate output data. The control configuration may include a non-volatile memory to store the program and a memory storing the data.

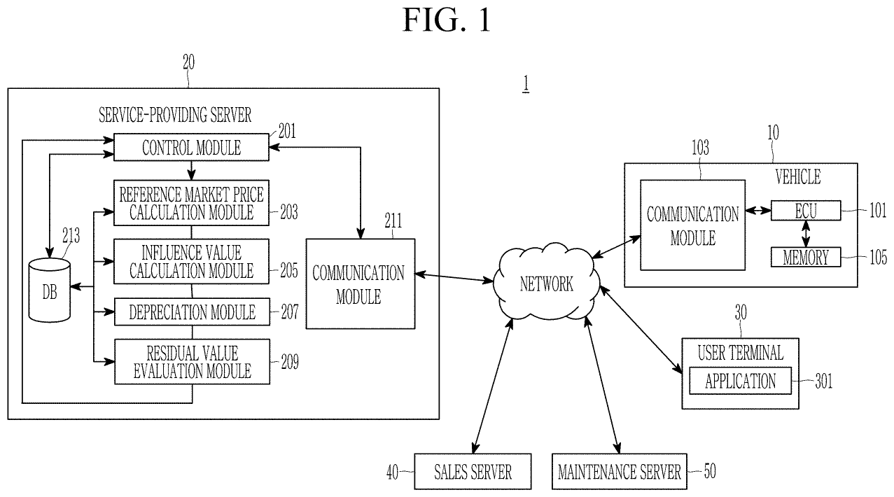

FIG. 1 is a block diagram schematically showing a configuration of a system for evaluating a residual value of a vehicle according to an exemplary embodiment.

Referring to FIG. 1, a system 1 for evaluating a residual value of a vehicle may include a vehicle 10, a service-providing server 20, and a user terminal 30.

The vehicle 10, the service-providing server 20 and the user terminal 30 may be connected to one another through a network.

In embodiments of the present invention, the network may include a personal area network (PAN), a local area network (LAN), a campus area network (CAN), a metropolitan area network (MAN), a wide area network (WAN), a broadband network (BBN), a wireless LAN (WLAN), a storage area network (SAN) or a controller area network (CAN), or may be a cellular communication such as a long term evolution (LTE), an LTE advanced (LTE-A), a code-division multiple access (CDMA), a wideband code division multiplex access (WCDMA), a universal mobile telecommunication system (UMTS), a wireless broadband (WiBro) or a global system for mobile communications (GSM), and is not limited thereto.

The vehicle 10 may include a memory 105 storing connected car information.

A connected car may refer to a vehicle which is connected to the network and may provide various services.

The connected car information may be information on the connected car, and categorized into sales information, product information, driving information, durability information, battery information, and management information. The connected car information may have different categories and detailed items in the categories, based on a power source of the vehicle 10, which is classified as an internal combustion engine or an electricity engine.

The sales information may include, as its detailed items, information on sales classification for distinguishing whether a vehicle is an individual vehicle or a corporate vehicle, purpose of use for distinguishing whether a vehicle is a private vehicle, a commercial vehicle or a rental car and a vehicle brand.

The product information may include, as its detailed items, information on an exterior color of the vehicle 10 and a selection option thereof such as a panoramic sunroof.

The driving information may include, as its detailed items, information on the regional driving ratio, driving ratio for each road type, idling ratio, rapid acceleration/deceleration ratio, and high revolution per minute (RPM) maintenance ratio of the vehicle 10.

Here, the regional driving ratio may be a driving ratio of the vehicle in a downtown area, a mountainous region, or a coastal region. The driving ratio for each road type may be a driving ratio of the vehicle on a highway, a national road, or a city road. The idling ratio may be an idle quantile. The rapid acceleration/deceleration ratio may be a quantile of the number of times vehicle acceleration exceeds reference acceleration. The high RPM maintenance ratio may be a quantile of the number of times a vehicle RPM exceeds a reference RPM.

The durability information may include, as its detailed items, information on the engine overload, transmission overload, engine operation number, and transmission operation number of the vehicle 10.

Here, the engine overload may be a quantile of the number of times a vehicle torque exceeds a reference torque. The transmission overload may be a quantile of the number of times a vehicle power exceeds a reference power. The engine operation number may be a quantile of the number of times a vehicle engine is started/accelerated. The transmission operation number may be a quantile of the number of times a transmission is shifted with respect to a reference number of the shifts.

The battery information may include, as its detailed items, information on the battery age, battery lifespan, battery warranty period, and battery charge type of the vehicle 10.

The management information may include, as its detailed items, information on the number of periodic inspection histories, general/insurance repair cost, warranty repair/pre-inspection cost, number of airbag deployment histories, and an accident portion of the vehicle 10.

The service-providing server 20 may include a control module 201, a reference market price calculation module 203, an influence value calculation module 205, a depreciation module 207, a residual value evaluation module 209, a communication module 211, and a database 213.

When receiving a residual value evaluation request from the user terminal 30 through the communication module 211, the control module 201 may operate the reference market price calculation module 203, the influence value calculation module 205, the depreciation module 207, and the residual value evaluation module 209. When receiving a residual value evaluation result from the residual value evaluation module 209, the control module 201 may transmit the same to the user terminal 30 through the communication module 211.

The control module 201 may record the sales information received from a sales server 40, the management information received from a maintenance server 50, and the connected car information received from the vehicle 10 in the database 213. The database 213 may include storage regions divided for each of the plurality of vehicles, in which the storage region for each vehicle 10 may include fields for each of the management information, the sales information, and the connected car information. The control module 201 may record the received management information, sales information and connected car information in a corresponding field.

The service-providing server 20 may include the database 213 storing data for evaluating a residual value of the vehicle 10.

The communication module 211 may transmit a control instruction of the control module 201 to the outside through the network, and transmit information received from the outside to the control module 201.

The database 213 may store the basic information, price information, connected car information, constant and regression coefficient of each detailed item in the basic information, an influence of each detailed item in a category of the connected car information, weight of each category, reference market price calculation formula, influence value calculation formula, depreciation ratio of each accident portion, information on a residual value evaluation formula and the like of the vehicle 10.

The basic information may include, as its detailed items, information on the mileage, vehicle age, fuel type, engine displacement, vehicle brand, cruising distance, battery capacity, and body type of the vehicle 10.

The price information may include, as its detailed items, information on a new vehicle price of the vehicle 10.

The influence may refer to a coefficient calculated using a weighted average method or a curve estimation method. The influence may be used to calculate the influence value by adding influences corresponding to respective detailed items in the category of the connected car information to each other or by applying the influence as the coefficient to an equation.

The weight may refer to a contribution to the residual value of the vehicle 10 in each category of the connected car information. The weight may be a coefficient calculated by reflecting opinions of the dealer and consumer of the vehicle 10 by a certain ratio.

The influence value may be a value calculated by multiplying a value calculated by using the influence of each detailed item in the category of the connected car information by a corresponding weight of each category.

The vehicle 10 may include an electronic control unit (ECU) 101, a communication module 103 and the memory 105.

The ECU 101 may generate, from operation data of the vehicle 10, information on the regional driving ratio, driving ratio for each road type, rapid acceleration/deceleration ratio, high RPM maintenance ratio, engine overload, transmission overload, engine operation number, transmission operation number and the like of the vehicle 10. When receiving a request for the connected car information from the service-providing server 20, the ECU 101 may transmit information stored in the memory 105 to the service-providing server 20 through the communication module 103.

The communication module 103 may transmit a control instruction of the ECU 101 to the outside through the network, and transmit information received from the outside to the ECU 101.

The memory 105 may store information generated by the ECU 101.

An application 301 may be installed in the user terminal 30.

The sales server 40 may transmit the sales information which may include, as its detailed items, the information on the sales classification, purpose of use and vehicle brand to the service-providing server 20 through the network.

The maintenance server 50 may transmit the management information which may include, as its detailed items, information on the number of periodic inspection histories, general/insurance repair cost, warranty repair/pre-inspection cost, number of airbag deployment histories and accident portion of the vehicle 10 to the service-providing server 20 through the network.

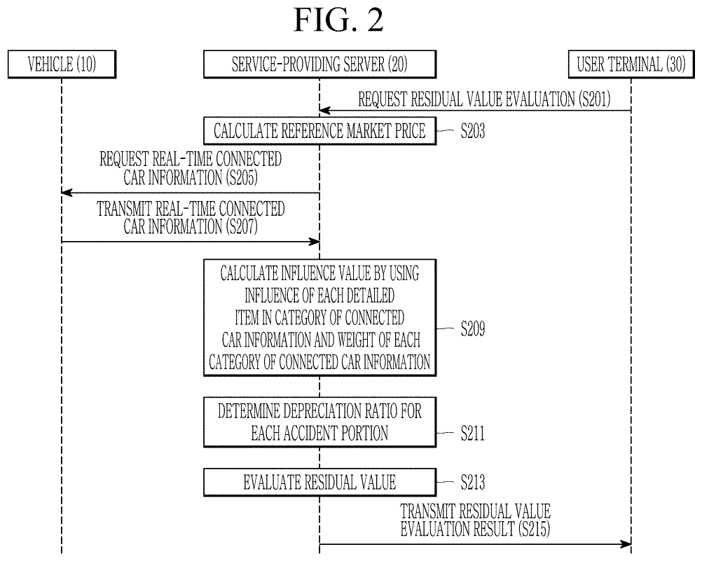

FIG. 2 is a flowchart showing a method for evaluating a residual value of a vehicle according to another exemplary embodiment.

The user terminal 30 may request the service-providing server 20 for a residual value evaluation of the vehicle 10 by using the application 301 (S201).

The service-providing server 20 may receive the residual value evaluation request for the vehicle 10 and calculate the reference market price (S203).

The reference market price calculation module 203 may calculate the reference market price by using the basic information of the vehicle 10, the price information, and the constant and regression coefficient of each detailed item in each category, which are stored in the database 213.

For example, when the power source of the vehicle 10 is the internal combustion engine, the reference market price calculation module 203 may calculate the reference market price by multiplying the new vehicle price by a value calculated by adding a value obtained by multiplying a value of each detailed item in the basic information and the regression coefficient to a constant term. This calculation may be expressed by Equation 1 below.

Reference market price={C+(Regression coefficient of vehicle age×Vehicle age)+(Regression coefficient of fuel type×Fuel type)+(Regression coefficient of mileage×Mileage)+(Regression coefficient of engine displacement×Engine displacement)}×New vehicle price [Equation 1]

Here, the vehicle age may be expressed in units of years, the mileage may be expressed in units of 1,000 km, and the engine displacement may be expressed as 1 in a case of a mainstream and zero (0) in the other cases.

The service-providing server 20 may request the vehicle 10 for real-time connected car information (S205).

The vehicle 10 may transmit the real-time connected car information stored in the memory 105 to the service-providing server 20 (S207).

For example, the vehicle 10 may store, in the memory 105, the real-time connected car information including the driving information such as the regional driving ratio and the durability information such as the engine overload. When receiving the request for the real-time connected car information from the service-providing server 20, the vehicle 10 may transmit the real-time connected car information up to time of receiving the request to the service-providing server 20.

The service-providing server 20 may then receive the real-time connected car information, and calculate the influence value by using the influence of each detailed item in the category of the received connected car information and the weight of each category of the connected car information (S209).

For example, the influence value calculation module 205 may calculate an influence value of each detailed item in the sales information by multiplying an influence of each detailed item in the sales information by a weight of the sales information, which are stored in the database 213. Here, a unit of the influence may be South Korean won (KRW) 10,000. This calculation may be expressed by Equation 2 below.

Influence value of each detailed item in sales information=Influence of each detailed item in sales information×Weight of sales information [Equation 2]

As a specific example, the influence value calculation module 205 may calculate an influence value of the vehicle brand, which is one of the detailed items of the sales information as follows. When the vehicle 10 is an internal combustion engine vehicle in a medium-sized vehicle class and having the vehicle brand of Hyundai, it may be assumed that KRW 219,600 is an influence of Hyundai, which is the vehicle brand having the medium-sized vehicle class, and 1.02 is a weight of the sales information of the internal combustion engine vehicle, which are stored in the database 213. The influence value calculation module 205 may calculate, as the influence value of the vehicle brand item in the sales information, KRW 224,000 which is a value obtained by multiplying KRW 219,600 as the influence of Hyundai, which is the vehicle brand in the mid-sized vehicle class, by 1.02 which is the weight of the sales information of the internal combustion engine vehicle.

As another specific example, when the vehicle 10 is an internal combustion engine vehicle in a small and semi-medium sized sport utility vehicle (SUV) class and used as a rental car, it may be assumed that KRW −1,989,000 is an influence of the vehicle, which is the small and semi-medium sized SUV class and has a purpose to be used as the rental car, and 1.02 is the weight of the sales information of the internal combustion engine vehicle, which are stored in the database 213. The influence value calculation module 205 may calculate, as an influence value of the purpose of use item in the sales information, KRW −2,028,800 which is a value obtained by multiplying KRW −1,989,000 as the influence of the vehicle, which is the small and semi-medium sized SUV class and has the purpose of use of the rental car, by 1.02 which is the weight of the sales information of the internal combustion engine vehicle.

As yet another example, the influence value calculation module 205 may calculate an influence value of each detailed item in the durability information by using at least one influence of each detailed item in the durability information, a value of each detailed item in the durability information, and a weight of the durability information, which are stored in the database 213. Here, a unit of the influence may be KRW 10,000. This calculation may be expressed by Equation 3 below.

Influence value of each detailed item in durability information={b0+(b1×Value of each detailed item in durability information)+(b2×Value of each detailed item in durability information?)}×Weight of durability information [Equation 3]

In Equation 3, at least one influence of each detailed item in the durability information may include the first influence b0, the second influence b1, and the third influence b2. Equation 3 describes that the number of the influences of at least one of each detailed item in the durability information is three, and embodiments of the present invention are not limited thereto.

As a specific example, when 50 is a transmission overload value of a medium-sized internal combustion engine vehicle, it may be assumed that KRW 295,900 is the first influence b0 of the transmission overload of the medium-sized vehicle, KRW −6,000 is the second influence b1 and 0.0015 is the third influence b2, which are stored in the database 213. The influence value calculation module 205 may calculate, as an influence value of the transmission overload item in the durability information, KRW 652,400 which is a value obtained by multiplying a value obtained by substituting the first to third influences into Equation 3, i.e. {29.59+(−0.60×50)+(0.0015×502)}=KRW 633,400, by 1.03 which a weight of the durability information of the internal combustion engine vehicle.

As still another example, the influence value calculation module 205 may calculate an influence value of each detailed item in the driving information by using at least one influence of each detailed item in the driving information, a value of each detailed item in the driving information and a weight of the driving information, which are stored in the database 213. Here, a unit of the influence may be KRW 10,000.

Influence value of each detailed item in driving information={c0+(c1×value of each detailed item in driving information)+(c2×value? of each detailed item in driving information)+(c3×value? of each detailed item in driving information)}×Weight of driving information [Equation 4]

In Equation 4, at least one influence of each detailed item in the driving information may include the first influence c0, the second influence c1, the third influence c2, and the fourth influence c3. Equation 4 describes that the number of the influences of at least one of each detailed item in the driving information is four, and embodiments of the present invention are not limited thereto.

As a specific example, when 50 is a rapid acceleration/deceleration quantile value of an electric vehicle, it may be assumed that KRW −202,900 is the first influence c0 of the rapid acceleration/deceleration quantile of the electric vehicle, KRW 340,200 is the second influence c1, KRW 212,100 is the third influence c2 and KRW −266,100 is the fourth influence c3, which are stored in the database 213. The influence value calculation module 205 may calculate, as an influence value of the rapid acceleration/deceleration quantile item in the driving information, a value obtained by multiplying a value obtained by substituting the first to fourth influences into Equation 4, i.e. {−20.29+(34.02×50)+(21.21×502)+(−26.61×503)}, by 1.12 which a weight of the driving information of the electric vehicle.

The influence value calculation module 205 may calculate the influence value of each detailed item in the category of the connected car information of the internal combustion engine vehicle or electric vehicle by using the same method as any one of the above-described methods of calculating the sales information, the durability information, and the driving information.

The influence value calculation module 205 may calculate the influence value of each detailed item by using the influence of each detailed item and the weight of the corresponding category for each of the plurality of detailed items, and sum the influence values of the plurality of detailed items to calculate the influence value of the connected car information.

A weight of each category of the connected car information may be set depending on a user type. A user may select the user type by using the application 301 to change the weight. The user type may be divided into emphasis on fuel efficiency, design, a high-speed performance, emotional quality deterioration or the like.

An influence of the warranty repair in detailed items of the management information may depend on whether a corresponding problem is resolved when the vehicle is subject to a recall or a campaign due to a defect in its specific part or control logic. For example, the influence of the warranty repair may be lower when the recalled part is not repaired compared to when repaired.

In addition, an influence of the periodic inspection history in the detailed items of the management information may depend on whether a consumable is replaced. For example, the influence of the periodic inspection history may be lower when the consumable to be replaced is not replaced compared to when replaced.

The service-providing server 20 may determine the depreciation ratio for each accident portion (S211).

For example, the depreciation module 207 may determine the depreciation ratio to be applied when evaluating the residual value of the vehicle 10 by using the accident portion of the vehicle 10 and the depreciation ratio for each accident portion, which are stored in the database 213.

In detail, when the accident portion of the vehicle 10 is a dash panel, the depreciation module 207 may determine from the information stored in the database 213 that the accident portion is the dash panel, and −20% is the depreciation ratio of the dash panel.

The depreciation module 207 may calculate a total depreciation ratio by summing the depreciation ratios of the respective accident portions to each other.

The service-providing server 20 may evaluate the residual value of the vehicle 10 (S213).

For example, the residual value evaluation module 209 may evaluate a residual value of the vehicle 10 by multiplying the depreciation ratio determined by the depreciation module 207 by a value obtained by adding the reference market price calculated by the reference market price calculation module 203 to the influence value of the connected car information, calculated by the influence value calculation module 205.

For example, the residual value evaluation module 209 may be corrected by multiplying a depreciation amount obtained by an influence value of the general/insurance repair cost, calculated in a step S209, and the depreciation ratio for each accident portion, calculated in a step S211, by a certain ratio. In this manner, it is possible to prevent a repair history of the accident portion from being redundantly considered in the determining of the depreciation ratio for each accident portion even though the repair history of the accident portion is already considered in the calculating of the influence value of the general/insurance repair cost, which is the detailed item in the management information in the category of the connected car information.

The service-providing server 20 may transmit the residual value evaluation result to the user terminal 30 (S215).

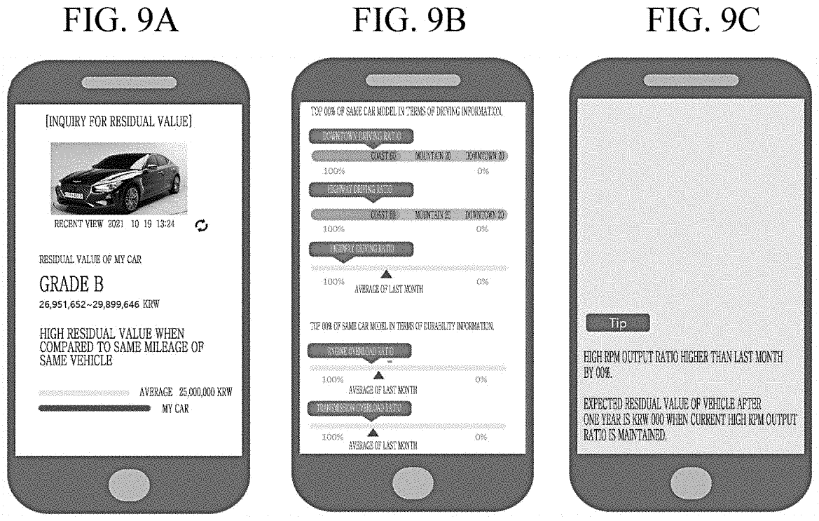

For example, referring to FIG. 9A, the user terminal 30 may display the residual value evaluation result transmitted from the service-providing server 20 on a screen of the user terminal 30 by using the application 301. The application 301 may display the residual value evaluation result of the vehicle 10 in a form of one price or grade information per one product on the screen of the user terminal 30.

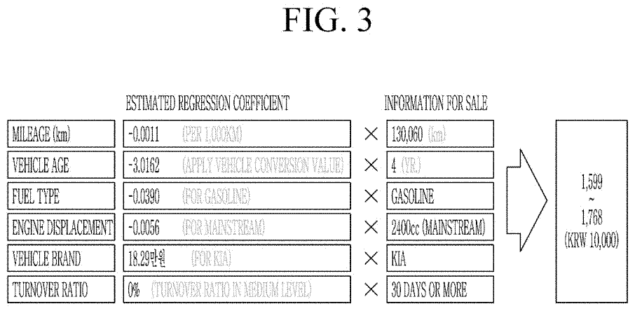

Hereinafter, the description describes a method for evaluating a residual value of an internal combustion engine vehicle according to another exemplary embodiment with reference to FIGS. 3 to 5.

FIG. 3 is a diagram showing a method of calculating a reference market price of a semi-large internal combustion engine vehicle according to another exemplary embodiment.

For example, the basic information of the vehicle 10 may include the mileage, the vehicle age, the fuel type, the engine displacement, the vehicle brand, and a turnover ratio.

In detail, according to another exemplary embodiment, it may be assumed that the vehicle 10 is the semi-large internal combustion engine vehicle, and has the mileage of 130,060 km, the vehicle age of 4 years, the fuel type of gasoline, the engine displacement of 2400 cc (mainstream), the vehicle brand of Kia, and the turnover of 30 days or more (or in a medium level).

The reference market price calculation module 203 may identify, from the regression coefficient data of each detailed item in the basic information, stored in the database 213, that −0.0011 per 1,000 km is a regression coefficient of the mileage item in the semi-large internal combustion engine vehicle, −3.0162 is a regression coefficient of the vehicle age item, −0.0390 is a regression coefficient of the fuel type item, −0.0056 is a regression coefficient of the engine displacement item in the mainstream, KRW 182,900 is a regression coefficient of the vehicle brand item for Kia, and zero (0) is a regression coefficient of the turnover item when the turnover is in the medium level.

Here, the reference market price calculation module 203 may calculate KRW 15,990,000 to 17,680,000 as the reference market price by using the value of each detailed item in the basic information and the regression coefficient of each detailed item in the basic information, as shown in Equation 1. In general, the new vehicle price may be in a predetermined range depending on an option installed on the vehicle, and the reference market price may thus also be in the predetermined range (of KRW 15,990,000 to 17,680,000).

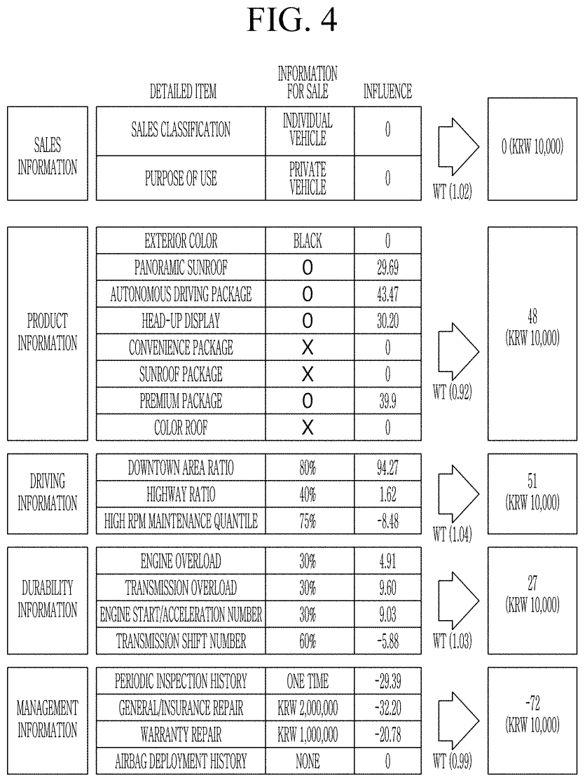

FIG. 4 is a diagram showing a method of calculating an influence value of the semi-large internal combustion engine vehicle according to another exemplary embodiment.

For example, the connected car information of the vehicle 10 may be categorized into the sales information, the product information, the driving information, the durability information, and the management information. The sales information may include the information on the sales classification and the purpose of use. The product information may include the information on the exterior color, the panoramic sunroof, an autonomous driving package, a head-up display, a convenience package, a sunroof package, a premium package, and a color roof. The driving information may include the information on the downtown area ratio, the highway ratio, and the high RPM maintenance quantile. The durability information may include the information on the engine overload, the transmission overload, the engine start/acceleration number, and the transmission shift number. The management information may include the information on the periodic inspection history, the general/insurance repair, the warranty repair, and the airbag deployment history.

In detail, it may be assumed that the vehicle 10 according to an exemplary embodiment is the semi-large internal combustion engine vehicle, and has the sales classification of the individual vehicle and the purpose of use of the private vehicle.

The influence value calculation module 205 may identify, from influence data of each detailed item in the sales information, stored in the database 213, that the individual vehicle has zero (0) for the influence of the sales category of the semi-large internal combustion engine vehicle, and the private vehicle has zero (0) for the influence of the purpose of use item.

Here, the influence value calculation module 205 may calculate the influence value of each detailed item in the sales information by multiplying a value calculated by using the value of each detailed item in the sales information and the influence of each detailed item in the sales information, as shown in Equation 2, by 1.02 which is the weight of the sales information. When an individual purchases the semi-large internal combustion engine vehicle as the private vehicle, zero (0) may be both the influences of the sales classification item and the purpose of use item, and also, zero (0) may be the influence value by the sales information.

Similarly, the influence value of each detailed item may be calculated by multiplying the weight of each category by a value calculated by using the value of each detailed item and influence of each detailed item in each category of the product information, driving information, durability information, and management information of the semi-large internal combustion engine vehicle according to an exemplary embodiment. In addition, the influence value of each category may be calculated by summing the influence values of the respective detailed items in the same category to each other. Here, KRW zero (0) may be the influence value of the sales information calculated in this manner, KRW 480,000 may be the influence value of the product information, KRW 510,000 may be the influence value of the driving information, KRW 270,000 may be the influence value of the durability information, and KRW −720,000 may be the influence value of the management information. The influence value calculation module 205 may calculate KRW 540,000 as the influence value of the connected car information by summing all the calculated influence values of the respective detailed items to each other.

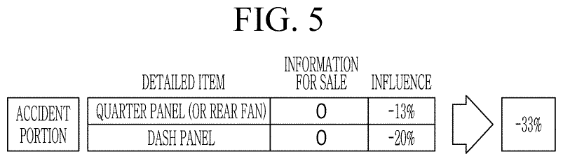

FIG. 5 is a diagram showing a method of determining a depreciation ratio of the semi-large internal combustion engine vehicle according to another exemplary embodiment.

For example, it may be assumed that the accident portion of the vehicle 10 is a quarter panel (or rear fan) and a dash panel.

In detail, the depreciation module 207 may identify, from the depreciation ratio data of each accident portion, stored in the database 213, that the depreciation ratio is −13% when the accident portion is the quarter panel (or rear fan) and −20% when the accident portion is the dash panel. The depreciation module 207 may calculate that a total depreciation ratio is −33% by summing the depreciation ratios of the respective accident portions to each other.

The residual value evaluation module 209 may then evaluate a residual value of the semi-large internal combustion engine vehicle according to another exemplary embodiment. In detail, it may be evaluated that the residual value of the vehicle 10 is KRW 11,080,000 to 12,200,000 by multiplying the above-described depreciation ratio −33% by a value obtained by adding KRW 15,990,000 to 17,680,000 which is the above-described reference market price value to KRW 540,000 which is the above-described influence value of the connected car information.

The control module 201 may receive KRW 11,080,000 to 12,200,000 as the residual value from the residual value evaluation module 209, and transmit the same to the user terminal 30 through the communication module 211.

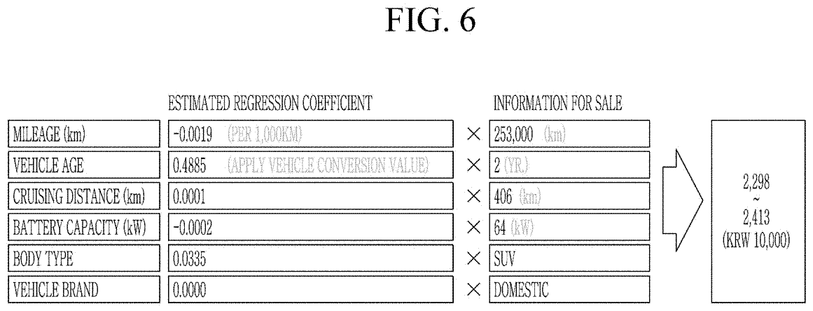

Hereinafter, the description describes a method for evaluating a residual value of an electric vehicle according to another exemplary embodiment with reference to FIGS. 6 to 8.

FIG. 6 is a diagram showing a method of calculating a reference market price of an electric vehicle according to another exemplary embodiment.

For example, the basic information of the vehicle 10 may include the mileage, the vehicle age, a cruising distance, a battery capacity, a body type, and the vehicle brand.

In detail, it may be assumed that the vehicle 10 according to an exemplary embodiment is the electric vehicle, and has the mileage of 253,000 km, the vehicle age of 2 years, the cruising distance of 406 km, the battery capacity of 64 kW, the body type of SUV, and a domestic vehicle brand.

The reference market price calculation module 203 may identify, from the regression coefficient data of each detailed item in the basic information, stored in the database 213, that −0.0019 per 1000 km is a regression coefficient of the mileage item of the electric vehicle, 0.4885 is a regression coefficient of the vehicle age item, 0.0001 is a regression coefficient of the cruising distance item, −0.0002 is a regression coefficient of the battery capacity, 0.0335 is a regression coefficient of the body type, and zero (0) is a regression coefficient of the vehicle brand when the vehicle brand is domestic.

Here, the reference market price calculation module 203 may calculate KRW 22,980,000 to 24,130,000 as the reference market price by using the value of each detailed item in the basic information and the regression coefficient of each detailed item in the basic information, as shown in Equation 1. In general, a new vehicle price may be in a predetermined range depending on an option installed on the vehicle, and the reference market price may thus also be in the predetermined range (of KRW 22,980,000 to 24,130,000).

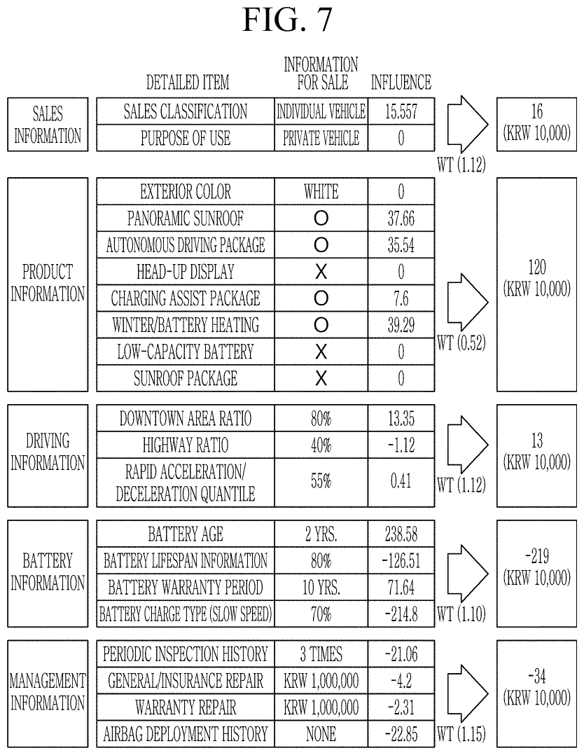

FIG. 7 is a diagram showing a method of calculating an influence value of the electric vehicle according to another exemplary embodiment.

For example, the connected car information of the vehicle 10 may be categorized into the sales information, the product information, the driving information, the battery information, and the management information. The sales information may include the information on the sales classification and the purpose of use. The product information may include the information on the exterior color, the panoramic sunroof, the autonomous driving package, the head-up display, a charging assist package, a winter/battery heating, a low-capacity battery, and the sunroof package. The driving information may include the information on the downtown area ratio, the highway ratio, and the rapid acceleration/deceleration quantile. The battery information may include information on the battery age, the battery lifespan, the battery warranty period, and the battery charge type. The management information may include the information on the periodic inspection history, the general/insurance repair, the warranty repair, and the airbag deployment history.

In detail, it may be assumed that the vehicle 10 according to an exemplary embodiment is the electric vehicle, and has the sales classification of the individual vehicle and the purpose of use of the private vehicle.

The influence value calculation module 205 may identify, from the influence data of each detailed item in the sales information, stored in the database 213, that the individual vehicle has 15.557 as the influence in the sales category of the electric vehicle, and the private vehicle has zero (0) as the influence of the purpose of use item.

Here, the influence value calculation module 205 may calculate the influence value of each detailed item in the sales information by multiplying the value calculated by using the value of each detailed item in the sales information and the influence of each detailed item in the sales information, as shown in Equation 2, by 1.12 which is the weight of the sales information. When an individual purchases the electric vehicle as the private vehicle, 15.557 may be the influence of the sales classification item and zero (0) may be the influence of the purpose of use item, and the influence value based on the sales information may thus be calculated by summing 15.557 multiplied by the weight of 1.12 and zero (0) multiplied by the weight of 1.12 to each other.

Similarly, the influence value of each detailed item may be calculated by multiplying the weight of each category by the value calculated using the value of each detailed item of the product information, driving information, battery information and management information of the electric vehicle according to an exemplary embodiment and the influence of each detailed item. In addition, the influence value of each category may be calculated by summing the influence values of the respective detailed items in the same category to each other. Here, KRW 160,000 may be the influence value of the sales information calculated in this manner, KRW 1,200,000 may be the influence value of the product information, KRW 130,000 may be the influence value of the battery information is, and KRW −2,190,000 may be the influence value of the management information. The influence value calculation module 205 may calculate KRW −1,800,000 as the influence value of the connected car information by summing all the calculated influence values of the respective detailed items to each other.

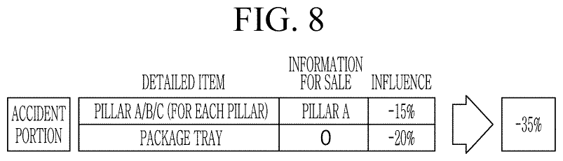

FIG. 8 is a diagram showing a method of determining a depreciation ratio of the electric vehicle according to another exemplary embodiment.

For example, it may be assumed that the accident portion of the vehicle 10 is a pillar A and a package tray.

In detail, the depreciation module 207 may identify, from the depreciation ratio data of each accident portion, stored in the database 213, that the depreciation ratio is −15% when the accident portion is the pillar A and −20% when the accident portion is the package tray. The depreciation module 207 may calculate that a total depreciation ratio is −35% by summing the depreciation ratios of the respective accident portions to each other.

The residual value evaluation module 209 may then evaluate a residual value of the electric vehicle according to another exemplary embodiment. In detail, it may be evaluated that the residual value of the vehicle 10 is KRW 13,760,000 to 14,510,000 by multiplying the above-described depreciation ratio −35% by a value obtained by adding KRW 22,980,000 to 24,130,000 which is the above-described reference market price value to KRW −1,800,000 which is the above-described influence value of the connected car information.

The control module 201 may receive KRW 13,760,000 to 14,510,000 as the residual value from the residual value evaluation module 209, and transmit the same to the user terminal 30 through the communication module 211.

FIGS. 9A to 9C show screens providing a service evaluating the residual value of a vehicle according to another exemplary embodiment.

Referring to FIG. 9A, the user terminal 30 may display the residual value evaluation result transmitted from the service-providing server 20 on the screen of the user terminal 30 by using the application 301. The application 301 may display the residual value evaluation result of the vehicle 10 in the form of one price or grade information per one product on the screen of the user terminal 30. In addition, the user terminal 30 may provide comparative information on the vehicle 10 and the same type of vehicle or the like on the screen of the user terminal 30 by using the application 301.

Whenever the user terminal 30 requests the service-providing server 20 to evaluate the residual value of the vehicle 10, the service-providing server 20 may evaluate the residual value by using the connected car information provided in real time from the vehicle 10. Accordingly, the user may be provided with information on the real-time residual value evaluation at a moment of inquiring the residual value of the vehicle 10 by using the application 301.

Referring to FIG. 9B, the user terminal 30 may provide the comparative information on the vehicle 10 and the same type of vehicle or the like and/or on the present state and the past history of the vehicle 10 for each detailed item of the connected car information on the screen of the user terminal 30 by using the application 301.

The application 301 may classify the user type by using the driving information and/or the durability information, stored in the database 213, and provide the classified user type on the screen of the user terminal 30. For example, the application 301 may classify the user type as an experienced driving type when the rapid acceleration/deceleration ratio of the user is lower than an average or as an inexperienced driving type when the ratio is higher than the average, and may provide this user type classification result on the screen of the user terminal 30. In addition, for example, the application 301 may classify the user type as a city type when the city-road driving ratio of the user is higher than an average or as a non-city type when the ratio is lower than the average, classify the user type as a long-distance type when a driving distance is greater than an average or as a short-distance type when the distance is smaller than the average, and provide the result on the screen of the user terminal 30.

Referring to FIG. 9C, the user terminal 30 may provide the comparative information on the present state and the past history of the vehicle 10 for each detailed item of the connected car information and information on an expected residual value of the vehicle 10 on the screen of the user terminal 30 by using the application 301.

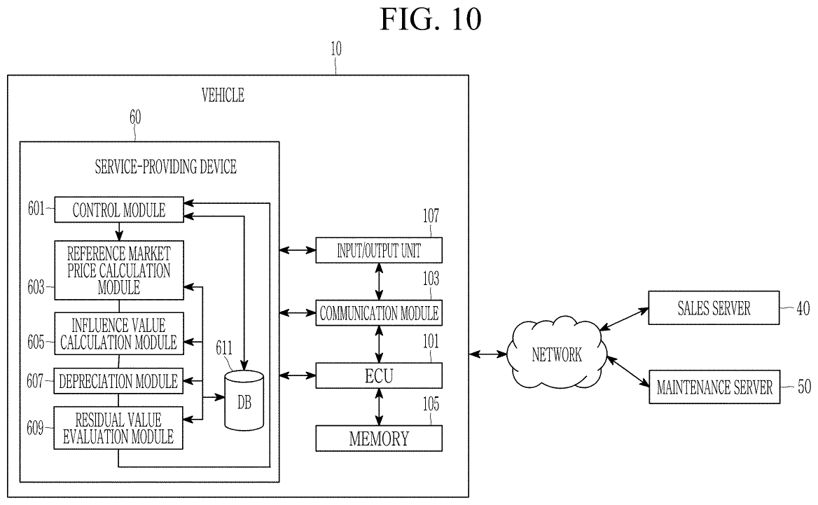

FIG. 10 is a block diagram schematically showing a configuration of a vehicle according to yet another exemplary embodiment.

Referring to FIG. 10, the vehicle 10 may include the ECU 101, the communication module 103, the memory 105, an input/output unit 107, and a service-providing device 60.

The ECU 101 may generate, from the operation data of the vehicle 10, the information on the regional driving ratio, the driving ratio for each road type, the rapid acceleration/deceleration ratio, the high RPM maintenance ratio, the engine overload, the transmission overload, the engine operation number, the transmission operation number and the like of the vehicle 10. When receiving the request for the connected car information from the service-providing device 60, the ECU 101 may transmit the information stored in the memory 105 to the service-providing device 60.

The communication module 103 may transmit the control instruction of the ECU 101 to the outside through the network, and transmit the information received from the outside to the ECU 101.

The memory 105 may store the information generated by the ECU 101.

The input/output unit 107 may generate input data for controlling an operation of the vehicle 10, and output an audio signal (or signal related to hearing), a video signal (or signal related to sight), an alarm signal or a signal related to tactile sense. For example, the input/output unit 107 may be a vehicle display installed in the vehicle 10. Alternatively, the vehicle 10 may receive the input data from the user terminal 30 through the network, and transmit output data of the vehicle 10 to the user terminal 30.

The service-providing device 60 may include a control module 601, a reference market price calculation module 603, an influence value calculation module 605, a depreciation module 607, a residual value evaluation module 609, and a database 611, and may be installed inside the vehicle.

The control module 601 may operate the reference market price calculation module 603, the influence value calculation module 605, the depreciation module 607, and the residual value evaluation module 609 when receiving the residual value evaluation request from the user terminal 30 through the input/output unit 107. The control module 601 may output the residual value evaluation result from the residual value evaluation module 609 by using the input/output unit 107. The control module 601 may record the sales information received from the sales server 40 and the management information received from the maintenance server 50 into the database 611.

The reference market price calculation module 603 may calculate the reference market price by using the basic information, price information, and constant and regression coefficient for each detailed item in each category of the vehicle 10, which are stored in the database 611.

The influence value calculation module 605 may calculate the influence value by using the received real-time influence of each detailed item in the category of the connected car information and the weight of each category in the connected car information.

The depreciation module 607 may determine the depreciation ratio of the vehicle 10 by using the accident portion of the vehicle 10 and the depreciation ratio for each accident portion, which are stored in the database 611.

The residual value evaluation module 609 may evaluate the real-time residual value of the vehicle 10 by using the reference market price, the influence value, and the depreciation ratio.

The database 611 may store the data for evaluating the residual value of the vehicle 10. Like the above-described database 213, the database 611 may store the basic information, price information, constant and regression coefficient of each detailed item in the basic information, influence of each detailed item in the category of the connected car information, weight of each category, reference market price calculation formula, influence value calculation formula, depreciation ratio for each accident portion, information on the residual value evaluation formula and the like of the vehicle 10.

Each module included in the service-providing device 60 may evaluate the residual value of the vehicle 10 by being operated similarly to the corresponding component of the above-described service-providing server 20. For example, the user may input the residual value evaluation request through the input/output unit 107. The control module 601 may operate the reference market price calculation module 603, the influence value calculation module 605, the depreciation module 607, and the residual value evaluation module 609, based on the request. The residual value evaluation module 609 may evaluate the residual value of the vehicle 10 by multiplying a value obtained by adding the reference market price calculated by the reference market price calculation module 603 to the influence value of the connected car information, calculated by the influence value calculation module 605, by the depreciation ratio determined by the depreciation module 607. The control module 601 may then output the received result by using the input/output unit 107 when receiving the residual value evaluation result from the residual value evaluation module 609.

The evaluation system according to this exemplary embodiment may resolve information asymmetry between the consumer and the used car dealer for the information that is difficult for the consumer to check the accurate information, such as the driving information and the durability information, by using the connected car, and identify the residual value of the vehicle in real time.

Although the exemplary embodiments of the present invention have been described in detail hereinabove, the scope of the present invention is not limited thereto. Various modifications and improvements made by those skilled in the art to which the present invention pertains also belong to the scope of the present invention.

What is claimed is:

1. A system for evaluating a residual value of a vehicle, the system comprising:
a service-providing server configured to:
receive a residual value evaluation request for the vehicle from a user terminal;
calculate a reference market price of the vehicle by using basic information of the vehicle and a regression coefficient corresponding to the basic information of the vehicle;
receive connected car information from the vehicle;
calculate an influence value of the connected car information by using the received connected car information;
determine a depreciation ratio for each accident portion of the vehicle;
evaluate the residual value of the vehicle by using the reference market price, the influence value of the connected car information and the depreciation ratio; and
transmit a residual value evaluation result of the vehicle to the user terminal in response to the request.

2. The system of claim 1, wherein
the service-providing server includes an influence value calculation module configured to calculate the influence value of the connected car information by using an influence of each detailed item in a category of the connected car information and a weight of each category in the connected car information; and
a residual value evaluation module configured to evaluate the residual value of the vehicle by multiplying the depreciation ratio by a sum of the reference market price and the influence value of the connected car information, the connected car information including the plurality of detailed items, and the plurality of detailed items being classified into at least two categories.

3. The system of claim 2, wherein the influence value calculation module is configured to:
calculate an influence value of each detailed item by using the influence of each detailed item and the weight of the corresponding category, for each of the plurality of detailed items; and
calculate the influence value of the connected car information by summing the influence values of the plurality of detailed items to each other, the influence of each detailed item being a value calculated using a weighted average method or a curve estimation method.

4. The system of claim 3, wherein the influence value calculation module is configured to calculate the influence value of each detailed item with respect to at least one of the plurality of detailed items by using an Equation 1:
Influence value of each detailed item=(Influence of corresponding detailed item)×(Weight of category corresponding to corresponding detailed item). [Equation 1]

5. The system of claim 3, wherein the influence value calculation module is configured to calculate the influence value of each detailed item with respect to at least one of the plurality of detailed items by using Equation 2:
Influence value of each detailed item={b0+(b1×(Value of corresponding detailed item))+(b2×(Value of corresponding detailed item²))}×(Weight of category corresponding to corresponding detailed item), [Equation 2]
wherein b0 is a first influence of the corresponding detailed item of the connected car information, b1 is a second influence of the corresponding detailed item of the connected car information, and b2 is a third influence of the corresponding detailed item of the connected car information.

6. The system of claim 3, wherein the influence value calculation module is configured to calculate the influence value of each detailed item with respect to at least one of the plurality of detailed items by using Equation 3:
Influence value of each detailed item={c0+(c1×Value of corresponding detailed item)+(c2×Value of corresponding detailed item²)+(c3×Value of corresponding detailed item³)}×(Weight of category corresponding to corresponding detailed item), [Equation 3]
wherein c0 is a first influence of the corresponding detailed item of the connected car information, c1 is a second influence of the corresponding detailed item of the connected car information, c2 is a third influence of the corresponding detailed item of the connected car information, and c3 is a fourth influence of the corresponding detailed item of the connected car information.

7. The system of claim 1, wherein
the vehicle is configured to transmit real-time connected car information up to time when the connected car information is requested from the service-providing server to the service-providing server; and
the service-providing server is configured to evaluate the residual value by using the real-time connected car information provided from the vehicle.

8. The system of claim 7, wherein the connected car information includes driving information, the driving information including information on the regional driving ratio, driving ratio for each road type, idling ratio, rapid acceleration/deceleration ratio, or high revolution per minute (RPM) maintenance ratio of the vehicle.

9. The system of claim 7, wherein the connected car information includes durability information, the durability information including information on the engine overload, transmission overload, engine operation number or transmission operation number of the vehicle.

10. The system of claim 1, wherein the service-providing server further includes:
a reference market price calculation module configured to calculate the reference market price by using the basic information as its detailed items, each detailed item in the basic information including at least one of the mileage, vehicle age, fuel type, engine displacement, vehicle brand, cruising distance, battery capacity and body type of the vehicle, price information, and constant and regression coefficient; and
a depreciation module configured to determine the depreciation ratio to be applied when evaluating the residual value of the vehicle by using the accident portion of the vehicle and the depreciation ratio for each accident portion.

11. A method for evaluating a residual value of a vehicle, the method comprising:
receiving a residual value evaluation request for the vehicle from a user terminal;
calculating a reference market price of the vehicle by using basic information of the vehicle and a regression coefficient corresponding to the basic information of the vehicle;
receiving connected car information from the vehicle;
calculating an influence value of the connected car information by using the received connected car information;
determining a depreciation ratio for each accident portion of the vehicle; and
evaluating the residual value of the vehicle by using the reference market price, the influence value of the connected car information and the depreciation ratio.

12. The method of claim 11, wherein:
the calculating of the influence value includes:
calculating the influence value of the connected car information by using an influence of each detailed item in a category of the connected car information and a weight of each category in the connected car information; and
the evaluating of the residual value includes:
evaluating the residual value of the vehicle by multiplying the depreciation ratio by a sum of the reference market price and the influence value of the connected car information, the connected car information including the plurality of detailed items, and the plurality of detailed items being classified into at least two categories.

13. The method of claim 12, wherein the calculating of the influence value of the connected car information includes:
calculating an influence value of each detailed item by using the influence of each detailed item and the weight of the corresponding category, for each of the plurality of detailed items; and
calculating the influence value of the connected car information by summing the influence values of the plurality of detailed items to each other, the influence of each detailed item being a value calculated using a weighted average method or a curve estimation method.

14. The method of claim 12, wherein the calculating of the influence value includes:
calculating the influence value of each detailed item with respect to at least one of the plurality of detailed items by using Equation 1:
Influence value of each detailed item=(Influence of corresponding detailed item)×(Weight of category corresponding to corresponding detailed item). [Equation 1]

15. The method of claim 12, wherein the calculating of the influence value includes:
calculating the influence value of each detailed item with respect to at least one of the plurality of detailed items by using Equation 2:
Influence value of each detailed item={b0+(b1×(Value of corresponding detailed item))+(b2×(Value of corresponding detailed item²))}×(Weight of category corresponding to corresponding detailed item), [Equation 2]
wherein b0 is a first influence of the corresponding detailed item of the connected car information, b1 is a second influence of the corresponding detailed item of the connected car information, and b2 is a third influence of the corresponding detailed item of the connected car information.

16. The method of claim 12, wherein the calculating of the influence value includes:
calculating the influence value of each detailed item with respect to at least one of the plurality of detailed items by using Equation 3:
Influence value of each detailed item={c0+(c1×Value of corresponding detailed item)+(c2×Value of corresponding detailed item²)+(c3×Value of corresponding detailed item³)}×(Weight of category corresponding to corresponding detailed item), [Equation 3]
wherein c0 is a first influence of the corresponding detailed item of the connected car information, c1 is a second influence of the corresponding detailed item of the connected car information, c2 is a third influence of the corresponding detailed item of the connected car information, and c3 is a fourth influence of the corresponding detailed item of the connected car information.

17. The method of claim 11, wherein:
the receiving of the connected car information from the vehicle includes:
receiving real-time connected car information up to time when the connected car information is requested from the vehicle; and
the evaluating of the residual value includes:
evaluating the residual value by using the real-time connected car information provided from the vehicle.

18. The method of claim 17, wherein the connected car information includes at least one of driving information and durability information, and the driving information including information on the regional driving ratio, driving ratio for each road type, idling ratio, rapid acceleration/deceleration ratio or high revolution per minute (RPM) maintenance ratio of the vehicle, the durability information including information on the engine overload, transmission overload, engine operation number or transmission operation number of the vehicle.

19. The method of claim 11, wherein:
the calculating of the reference market price includes:
calculating the reference market price by using the basic information as its detailed items, information on at least one of the mileage, vehicle age, fuel type, engine displacement, vehicle brand, cruising distance, battery capacity and body type of the vehicle, price information, and constant and regression coefficient of each detailed item in the basic information; and
the determining of the depreciation ratio for each accident portion includes:
determining the depreciation ratio to be applied when evaluating the residual value of the vehicle by using the accident portion of the vehicle and the depreciation ratio for each accident portion.

20. A method for evaluating a residual value of a vehicle, the method comprising:
receiving a residual value evaluation request for the vehicle from a user terminal;
calculating a reference market price of the vehicle by using basic information of the vehicle and a regression coefficient corresponding to the basic information of the vehicle;
calculating an influence value of connected car information by using the connected car information, determining a depreciation ratio for each accident portion of the vehicle;
evaluating a residual value of the vehicle by using the reference market price, the influence value of the connected car information and the depreciation ratio when receiving the residual value evaluation request for the vehicle, wherein the connected car information is real-time information up to time when the residual value evaluation request is received; and
transmitting a residual value evaluation result of the vehicle to the user terminal in response to the request.
